(19) United States
(12) Patent Application Publication
(10) Pub. No.: US 2024/0179289 A1
(43) Pub. Date: May 30, 2024

(54) 3D PROJECTION METHOD AND 3D PROJECTION DEVICE

(71) Applicant: Coretronic Corporation, Hsin-Chu (TW)

(72) Inventors: Wen-Bin Chien, Hsin-Chu (TW); Te-Sung Su, Hsin-Chu (TW); Wei-Chia Lai, Hsin-Chu (TW); Yen-Yu Chou, Hsin-Chu (TW)

(73) Assignee: Coretronic Corporation, Hsin-Chu (TW)

(21) Appl. No.: 18/513,643

(22) Filed: Nov. 20, 2023

(30) Foreign Application Priority Data
Nov. 24, 2022 (CN) 202211483269.0

(51) Int. Cl. H04N 13/302; G02B 30/26; H04N 13/363

(52) U.S. Cl. CPC H04N 13/302; G02B 30/26; H04N 13/363

(57) ABSTRACT

A 3D projection method and a 3D projection device are provided. The method includes: obtaining a first eye image and a second eye image, and forming a fusion image accordingly, wherein the fusion image includes multiple pixel groups, and each pixel group includes a first pixel, a second pixel, a third pixel and a fourth pixel; respectively generating a first projection image, a second projection image, a third projection image, and a fourth projection image based on the first, second, third, and fourth pixel of the pixel groups; and sequentially projecting the first, second, third and fourth projection images. The first and third projection images correspond to the first eye image, the second and fourth projection images correspond to the second eye image, and the first and second eye images are respectively one and another of the left and right eye image.

### CROSS-REFERENCE TO RELATED APPLICATION

This application claims the priority benefit of China application serial no. 202211483269.0, filed on Nov. 24, 2022. The entirety of the above-mentioned patent application is hereby incorporated by reference herein and made a part of this specification.

### BACKGROUND

### Technical Field

The disclosure relates to a projection mechanism, and in particular relates to a 3D projection method and a 3D projection device.

### Description of Related Art

With the improvement of the manufacturing technology of display panels, the resolution of a display panel on the market has been increased from the original 2K (i.e., 1920*1080) resolution to 4K (i.e., 3840*2160) resolution. However, for projectors, the rate of improvement in resolution is relatively slow. In the prior art, current projectors use a digital micromirror device (DMD) having a 1920*1080 or 2712*1528 resolution with a four-way (4Way) or two-way (2Way) actuator to achieve 4K resolution, that is, an extended pixel resolution (XPR) technology in digital light processing (DLP) is used. Although the image quality produced by DLP XPR technology is still far behind that of native 4K, it may greatly reduce the cost of 4K projectors.

In the case of general 2D projection, a DMD having 1920*1080 resolution with a four-way actuator may achieve a resolution of 4K60 Hz. However, in a 3D projection scenario where left and right eye images need to be presented, the current upper limit of XPR development is a bandwidth of only 600 MHz per unit time, and the corresponding upper limit of resolution and frequency is about 2200*1125 and 60 Hz. In other words, XPR may only support image information such as 4K (3840*2160) and 60 Hz, or 2K HD (1920*1080) and 240 Hz, whose total resolution information is below 600 MHz. However, when performing 3D projection, the frequency is required to be higher than 120 Hz. In this case, a trade-off between frequency and resolution is required, and both parameters cannot be raised to the highest.

In addition, in the prior art, there is also a practice of disabling the image processing function of the XPR, not driving the actuator, and directly outputting images with the preset native DMD resolution. However, since the current resolution limit supported by the DMD is 2K, when encountering an input image signal with a resolution exceeding 2K, the image is required to be compressed, resulting in a decrease in resolution.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

In view of this, the present invention provides a 3D projection method and a 3D projection device, which may be used to solve the aforementioned technical issues.

The other objectives and advantages of the present invention may be further understood from the descriptive features disclosed in the present invention.

In order to achieve one of, or portions of, or all of the above objectives or other objectives, an embodiment of the present invention provides a 3D projection method suitable for a 3D projection device, including the following operation. A first eye image and a second eye image are obtained, and a fusion image is formed of the first eye image and the second eye image. The fusion image includes multiple pixel groups, and each of the pixel groups includes a first pixel, a second pixel, a third pixel, and a fourth pixel. A first projection image is generated based on the first pixels of the pixel groups. A second projection image is generated based on the second pixels of the pixel groups. A third projection image is generated based on the third pixels of the pixel groups. A fourth projection image is generated based on the fourth pixels of the pixel groups. The first projection image, the second projection image, the third projection image, and the fourth projection image are sequentially projected. The first projection image and the third projection image correspond to the first eye image, the second projection image and the fourth projection image correspond to the second eye image, the first eye image is one of a left eye image and a right eye image, and the second eye image is another one of the left eye image and the right eye image.

In one embodiment of the present invention, the first pixel, the second pixel, the third pixel, and the fourth pixel in each of the pixel groups are arranged into a 2×2 pixel array. The first pixel and the third pixel in each of the pixel groups are arranged along a first diagonal direction, and the second pixel and the fourth pixel in each of the pixel group are arranged along a second diagonal direction perpendicular to the first diagonal direction.

In an embodiment of the present invention, the first pixel and the third pixel in each of the pixel groups are from the first eye image, and the second pixel and the fourth pixel in each of the pixel groups are from the second eye image.

In an embodiment of the present invention, the pixel groups include a first pixel group. The first pixel in the first pixel group has a first coordinate in the fusion image, the first eye image includes multiple first eye pixels, and the method includes the following operation. A first reference eye pixel is found from the first eye pixels, in which the first reference eye pixel corresponds to the first coordinate in the first eye image. The first pixel in the first pixel group is set to correspond to the first reference eye pixel.

In an embodiment of the present invention, the second pixel in the first pixel group has a second coordinate in the fusion image, the second eye image includes multiple second eye pixels, and the method includes the following operation. A second reference eye pixel is found from the second eye pixels, in which the second reference eye pixel corresponds to the second coordinate in the right eye image. The second pixel in the first pixel group is set to correspond to the second reference eye pixel.

In an embodiment of the present invention, sequentially projecting the first projection image, the second projection image, the third projection image, and the fourth projection image includes the following operation. The first projection image is shifted to a first position along a first direction by an image shifting device of the 3D projection device. The second projection image is shifted to a second position along a second direction by the image shifting device. The third projection image is shifted to a third position along a third direction by the image shifting device. The fourth projection image is shifted to a fourth position along a fourth direction by the image shifting device.

In an embodiment of the present invention, the first projection image, the second projection image, the third projection image, and the fourth projection image have a same shifted distance.

In an embodiment of the present invention, the second direction is perpendicular to the first direction, the third direction is opposite to the first direction, and the fourth direction is opposite to the second direction.

In an embodiment of the present invention, the 3D projection method includes the following operation. The image shifting device shifts the first projection image from a preset position to the first position along the first direction, shifts the second projection image from the preset position to the second position along the second direction, shifts the third projection image from the preset position to the third position along the third direction, and shifts the fourth projection image from the preset position to the fourth position along the fourth direction.

In an embodiment of the present invention, the 3D projection method includes the following method. In response to the first projection image being shifted to the first position, a 3D glasses is controlled to enable a first lens corresponding to a first eye and disable a second lens corresponding to a second eye. In response to the second projection image being shifted to the second position, the 3D glasses is controlled to disable the first lens corresponding to the first eye and enable the second lens corresponding to the second eye. In response to the third projection image being shifted to a third position, the 3D glasses is controlled to enable the first lens corresponding to the first eye and disable the second lens corresponding to the second eye. In response to the fourth projection image being shifted to the fourth position, the 3D glasses is controlled to disable the first lens corresponding to the first eye and enable the second lens corresponding to the second eye.

An embodiment of the present invention provides a 3D projection device, including an image processing device and an image shifting device. The image processing device is configured to perform the following operation. A first eye image and a second eye image are obtained, and the first eye image and the second eye image are fused as a fusion image. The fusion image includes multiple pixel groups, and each of the pixel groups includes a first pixel, a second pixel, a third pixel, and a fourth pixel. A first projection image is generated based on the first pixels of the pixel groups. A second projection image is generated based on the second pixels of the pixel groups. A third projection image is generated based on the third pixels of the pixel groups. A fourth projection image is generated based on the fourth pixels of the pixel groups. The image shifting device is coupled to the image processing device and is configured to perform the following operation. The first projection image, the second projection image, the third projection image, and the fourth projection image are sequentially projected. The first projection image and the third projection image correspond to the first eye image, the second projection image and the fourth projection image correspond to the second eye image, the first eye image is one of a left eye image and a right eye image, and the second eye image is another one of the left eye image and the right eye image.

In one embodiment of the present invention, the first pixel, the second pixel, the third pixel, and the fourth pixel in each of the pixel groups are arranged into a 2×2 pixel array. The first pixel and the third pixel in each of the pixel groups are arranged along a first diagonal direction, and the second pixel and the fourth pixel in each of the pixel group are arranged along a second diagonal direction perpendicular to the first diagonal direction.

In an embodiment of the present invention, the first pixel and the third pixel in each of the pixel groups are from the first eye image, and the second pixel and the fourth pixel in each of the pixel groups are from the second eye image.

In an embodiment of the present invention, the pixel groups include a first pixel group. The first pixel in the first pixel group has a first coordinate in the fusion image, the first eye image includes multiple first eye pixels, and the image processing device performs the following operation. A first reference eye pixel is found from the first eye pixels, in which the first reference eye pixel corresponds to the first coordinate in the first eye image. The first pixel in the first pixel group is set to correspond to the first reference eye pixel.

In an embodiment of the present invention, the second pixel in the first pixel group has a second coordinate in the fusion image, the second eye image includes multiple second eye pixels, and the image processing device performs the following operation. A second reference eye pixel is found from the second eye pixels, in which the second reference eye pixel corresponds to the second coordinate in the right eye image. The second pixel in the first pixel group is set to correspond to the second reference eye pixel.

In an embodiment of the present invention, the image shifting device performs the following operation. The image shifting device shifts the first projection image from a preset position to the first position along the first direction, shifts the second projection image from the preset position to the second position along the second direction, shifts the third projection image from the preset position to the third position along the third direction, and shifts the fourth projection image to the fourth position along the fourth direction.

In an embodiment of the present invention, the first projection image, the second projection image, the third projection image, and the fourth projection image have a same shifted distance.

In an embodiment of the present invention, the second direction is perpendicular to the first direction, the third direction is opposite to the first direction, and the fourth direction is opposite to the second direction.

In an embodiment of the present invention, the image shifting device performs the following operation. The image shifting device respectively shifts the first projection image to the first position along the first direction, shifts the second projection image to the second position along the second direction, shifts the third projection image to the third position along the third direction, and shifts the fourth projection image to the fourth position along the fourth direction from a preset position.

In an embodiment of the present invention, the image processing device performs the following method. In response to the first projection image being shifted to the first position, a 3D glasses is controlled to enable a first lens corresponding to a first eye and disable a second lens corresponding to a second eye. In response to the second projection image being shifted to the second position, the 3D glasses is controlled to disable the first lens corresponding to the first eye and enable the second lens corresponding to the second eye. In response to the third projection image being shifted to a third position, the 3D glasses is controlled to enable the first lens corresponding to the first eye and disable the second lens corresponding to the second eye. In response to the fourth projection image being shifted to the fourth position, the 3D glasses is controlled to disable the first lens corresponding to the first eye and enable the second lens corresponding to the second eye.

To sum up, the method of the embodiment of the present invention may use the pixels in each of the pixel groups to form different projections after generating a fusion image including multiple pixel groups based on the first eye image and the second eye image in a specific manner, and the projection images corresponding to both eyes of the user are projected in turn. In this way, the effect of residual vision may be achieved in the eyes of the user, so that the user may enjoy the experience of viewing 3D projection content with good resolution.

In order to make the above-mentioned and other objects, features and advantages of the present invention comprehensible, preferred embodiments accompanied with drawings are described in detail below.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a 3D projection device according to an embodiment of the present invention.

FIG. 2 is a flowchart of a 3D projection method according to an embodiment of the present invention.

FIG. 3 is a schematic diagram of forming a fusion image according to an embodiment of the present invention.

FIG. 4 is a schematic diagram of generating a projection image based on the fusion image shown in FIG. 3.

FIG. 5A to FIG. 5D are schematic diagrams of projecting multiple projection images according to FIG. 4.

FIG. 6 is a schematic diagram of sequentially projecting multiple projection images according to FIG. 5A to FIG. 5D.

### DETAILED DESCRIPTION OF DISCLOSED EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The above and other technical contents, features and effects of the disclosure will be clear from the below detailed description of an embodiment of the disclosure with reference to accompanying drawings. The directional terms mentioned in the embodiments below, like “above”, “below”, “left”, “right”, “front”, and “back”, refer to the directions in the appended drawings. Therefore, the directional terms are used to illustrate rather than limit the disclosure.

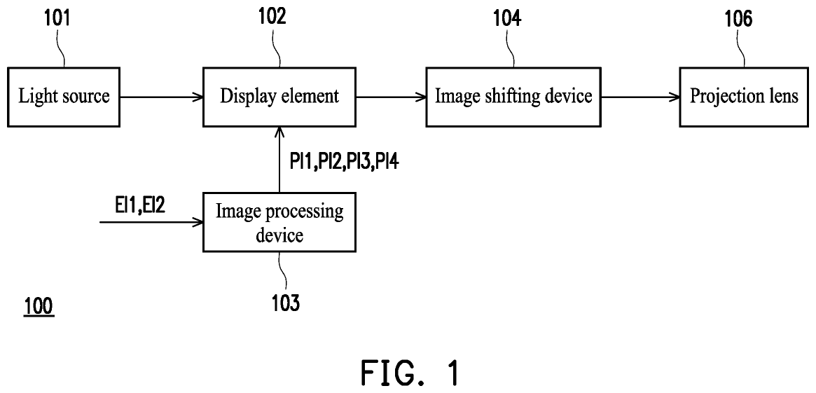

Referring to FIG. 1, FIG. 1 is a schematic diagram of a 3D projection device according to an embodiment of the present invention. In the embodiment of the present invention, the 3D projection device 100 is, for example, a 3D projector capable of 3D projection.

In FIG. 1, a 3D projection device 100 may include a light source 101, a display element 102, an image processing device 103, an image shifting device 104, and a projection lens 106. The light source 101 may generate light beams, and the light beams may be guided to the display element 102, so that the display element 102 modulates the received light beams in response to the image data provided by the image processing device 103 to form a projection image.

In FIG. 1, the image processing device 103 may be a general purpose processor, a special purpose processor, a conventional processor, a digital signal processor, multiple microprocessors, one or more combined digital signal processing microprocessor, a microcontroller, an application specific integrated circuit (ASIC), a field programmable gate array (FPGA), any other type of integrated circuit, state machine, advanced RISC machine (ARM) based processor and the like.

In one embodiment, the image shifting device 104 is, for example, an XPR device, which may shift the projection image provided by the display element 102 to a specific position through a multi-way (for example, four-way or two-way) actuator, and the projection image shifted to a specific position may then be projected onto a projection surface such as a projection screen or a wall through the projection lens 106.

In one embodiment, the display element 102 may be a spatial light modulator, such as a DMD, which may be, for example, controlled by a distributed data processor (DDP) (not shown) in the 3D projection device 101 to adjust the configuration of the micromirror matrix, but not limited thereto.

In one embodiment, the 3D projection device 100 may be connected to 3D glasses that may be worn by the user through wired or wireless methods, and may control the enabling or disabling of the first lens and the second lens of the 3D glasses when performing 3D projection. For example, when the 3D projection device 100 projects a projection image corresponding to the first eye (e.g., the left eye), the 3D projection device 100 may enable the first lens (e.g., the left eye lens) and disable the second lens (e.g., the right eye lens) of the 3D glasses, so that the projection image corresponding to the first eye enters the first eye of the user through the first lens after being reflected by a projection surface such as a projection screen or a wall, and that the projection image corresponding to the second eye is reflected by the projection surface such as a projection screen or a wall, and then is blocked by the second lens and cannot enter the second eye (e.g., the right eye) of the user. In this way, the user may only use the first eye to see the projection image corresponding to the first eye. In addition, when the 3D projection device 100 projects a projection image corresponding to the second eye, the 3D projection device 100 may enable the second lens and disable the first lens of the 3D glasses, so that the projection image corresponding to the second eye enters the second eye of the user through the second lens after being reflected by a projection surface such as a projection screen or a wall, and that the projection image corresponding to the first eye is reflected by the projection surface such as a projection screen or a wall, and then is blocked by the first lens and cannot enter the first eye of the user. In this way, the user may only use the second eye to see the projection image corresponding to the second eye.

In the embodiment of the present invention, the 3D projection device 100 may project the projection images corresponding to the left and right eyes at a frequency not lower than 120 Hz by implementing the 3D projection method provided by the present invention, so as to achieve the effect of residual vision in the eyes of the user, thereby the user may enjoy the experience of viewing 3D projection content. This is further described below.

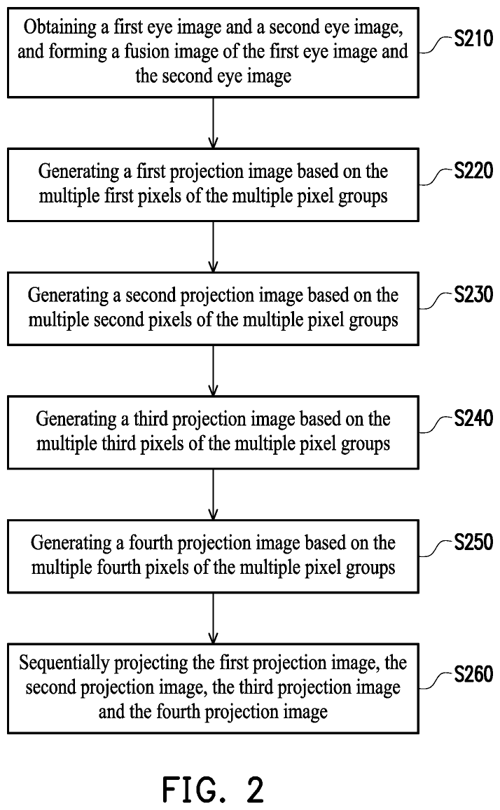

Referring to FIG. 2, FIG. 2 is a flowchart of a 3D projection method according to an embodiment of the present invention. The method of this embodiment may be executed by the 3D projection device 100 in FIG. 1 after being configured, and the details of each step in FIG. 2 will be described below with reference to the elements shown in FIG. 1.

First, in step S210, the image processing device 103 obtains the first eye image EI1 and the second eye image EI2, and forms a fusion image F1 of the first eye image EI1 and the second eye image EI2. In the embodiment of the present invention, the first eye image EI1 is one of the left eye image and the right eye image to be projected, and the second eye image EI2 is the other one of the left eye image and the right eye image to be projected.

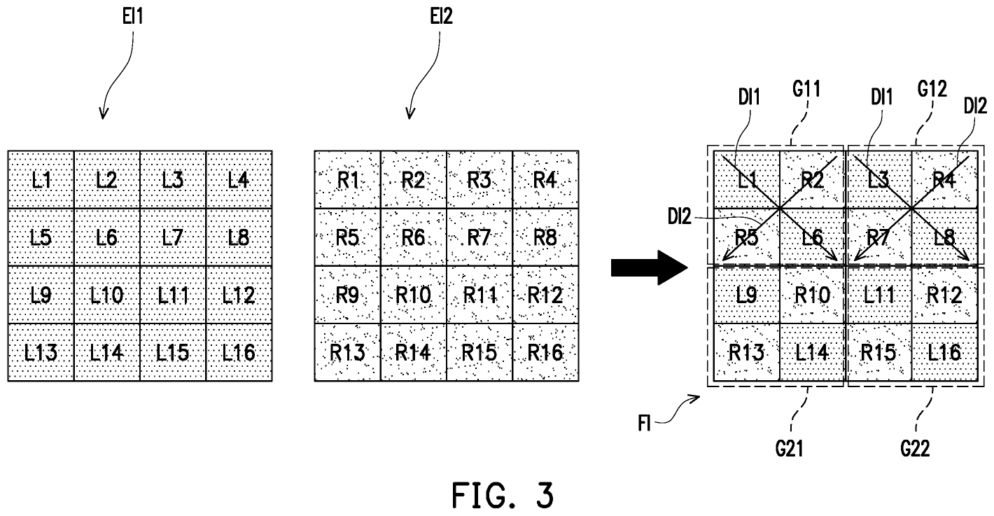

Referring to FIG. 3, FIG. 3 is a schematic diagram of forming a fusion image according to an embodiment of the present invention. To illustrate the concept of the present invention, the resolutions of the first eye image EI1 and the second eye image EI2 in FIG. 3 are respectively assumed to be 4×4. In other embodiments, the concept of the present invention is applicable to the first eye image EI1 and the second eye image EI2 with other resolutions (such as 4K or higher), and is not limited to the configuration shown in FIG. 3.

In FIG. 3, it is assumed that the first eye image EI1 includes first eye pixels L1 to L16, the second eye image EI2 includes second eye pixels R1 to R16, and the image processing device 103 may form a fusion image F1 accordingly.

In this embodiment, the fusion image F1 includes multiple pixel groups G11, G12, G21, and G22, and each of the pixel groups G11, G12, G21, and G22 includes a first pixel, a second pixel, a third pixel, and a fourth pixel.

In an embodiment, the image processing device 103 may determine the content of each of the pixel group G11, G12, G21, and G22 in a specific manner. For ease of understanding, the pixel group G11 is taken as an example for illustration below.

In one embodiment, the first pixel, the second pixel, the third pixel, and the fourth pixel in the pixel group G11 may be arranged as a 2×2 pixel array. In addition, the first pixel and the third pixel in the pixel group G11 are arranged along a first diagonal direction DI1, and the second pixel and the fourth pixel in the pixel group G11 are arranged along a second diagonal direction DI2 perpendicular to the first diagonal direction DI1.

In one embodiment, the first pixel and the third pixel in the pixel group G11 are from the first eye image EI1, and the second pixel and the fourth pixel in the pixel group G11 are from the second eye image EI2.

In FIG. 3, the first pixel, the second pixel, the third pixel, and the fourth pixel in the pixel group G11 are respectively, for example, the first eye pixel L1, the second eye pixel R2, the first eye pixel L6, and the second eye pixel R5.

In one embodiment, when determining the content of the pixel group G11, the image processing device 103 may first determine the first coordinate of the first pixel in the pixel group G11 in the fusion image F1, and find the first reference eye pixel with the corresponding coordinate in the first eye image EI1. Afterwards, the image processing device 103 may set the first pixel in the pixel group G11 to correspond to the first reference eye pixel.

For example, assuming that the coordinate of the first pixel in the pixel group G11 is (0,0) in the fusion image F1, the image processing device 103 may find the first eye pixel L1 with the coordinate (0,0) in the first eye image EI1 as the first reference eye pixel. Afterwards, the image processing device 103 may set the first pixel in the pixel group G11 to correspond to the first reference eye pixel (i.e., the first eye pixel L1).

In addition, the image processing device 103 may determine the second coordinate of the second pixel in the pixel group G11 in the fusion image F1, and find the second reference eye pixel with the corresponding coordinates in the second eye image EI2. Afterwards, the image processing device 103 may set the second pixel in the pixel group G11 to correspond to the second reference eye pixel.

For example, assuming that the coordinate of the second pixel in the pixel group G11 is (0,1) in the fusion image F1, the image processing device 103 may find the second eye pixel R2 with the coordinate (0,1) in the second eye image EI2 as the second reference eye pixel. Afterwards, the image processing device 103 may set the second pixel in the pixel group G11 to correspond to the second reference eye pixel (i.e., the second eye pixel R2).

In an embodiment, the image processing device 103 may determine the third pixel and the fourth pixel in the pixel group G11 based on the above principle.

For example, assuming that the coordinate of the third pixel in the pixel group G11 is (1,1) in the fusion image F1, the image processing device 103 may find the first eye pixel L6 with the coordinate (1,1) in the first eye image EI1 as the third reference eye pixel. Afterwards, the image processing device 103 may set the third pixel in the pixel group G11 to correspond to the third reference eye pixel (i.e., the first eye pixel L6).

In addition, assuming that the coordinate of the fourth pixel in the pixel group G11 is (1,0) in the fusion image F1, the image processing device 103 may find the second eye pixel R5 with the coordinate (1,0) in the second eye image EI2 as the fourth reference eye pixel. Afterwards, the image processing device 103 may set the fourth pixel in the pixel group G11 to correspond to the fourth reference eye pixel (i.e., the second eye pixel R5).

In FIG. 3, the first pixel, the second pixel, the third pixel, and the fourth pixel in the pixel group G12 may be arranged as a 2×2 pixel array. In addition, the first pixel and the third pixel in the pixel group G12 are arranged along a first diagonal direction DI1, and the second pixel and the fourth pixel in the pixel group G12 are arranged along a second diagonal direction DI2 perpendicular to the first diagonal direction DI1.

In one embodiment, the first pixel and the third pixel in the pixel group G12 are from the first eye image EI1, and the second pixel and the fourth pixel in the pixel group G12 are from the second eye image EI2.

In FIG. 3, the first pixel, the second pixel, the third pixel, and the fourth pixel in the pixel group G12 are respectively, for example, the first eye pixel L3, the second eye pixel R4, the first eye pixel L8, and the second eye pixel R7.

Assuming that the coordinate of the first pixel in the pixel group G12 is (0,3) in the fusion image F1, the image processing device 103 may find the first eye pixel L3 with the coordinate (0,3) in the first eye image EI1 as the first reference eye pixel. Afterwards, the image processing device 103 may set the first pixel in the pixel group G12 to correspond to the first reference eye pixel (i.e., the first eye pixel L3).

Assuming that the coordinate of the second pixel in the pixel group G12 is (0,4) in the fusion image F1, the image processing device 103 may find the second eye pixel R4 with the coordinate (0,4) in the second eye image EI2 as the second reference eye pixel. Afterwards, the image processing device 103 may set the second pixel in the pixel group G12 to correspond to the second reference eye pixel (i.e., the second eye pixel R4).

For example, assuming that the coordinate of the third pixel in the pixel group G12 is (1,4) in the fusion image F1, the image processing device 103 may find the first eye pixel L8 with the coordinate (1,4) in the first eye image EI1 as the third reference eye pixel. Afterwards, the image processing device 103 may set the third pixel in the pixel group G12 to correspond to the third reference eye pixel (i.e., the first eye pixel L8).

In addition, assuming that the coordinate of the fourth pixel in the pixel group G12 is (1,3) in the fusion image F1, the image processing device 103 may find the second eye pixel R7 with the coordinate (1,3) in the second eye image EI2 as the fourth reference eye pixel. Afterwards, the image processing device 103 may set the fourth pixel in the pixel group G12 to correspond to the fourth reference eye pixel (i.e., the second eye pixel R7).

Based on the above teachings, those skilled in the art should be able to deduce the formation process of the other pixel groups G21 and G22 accordingly, and details are not repeated herein.

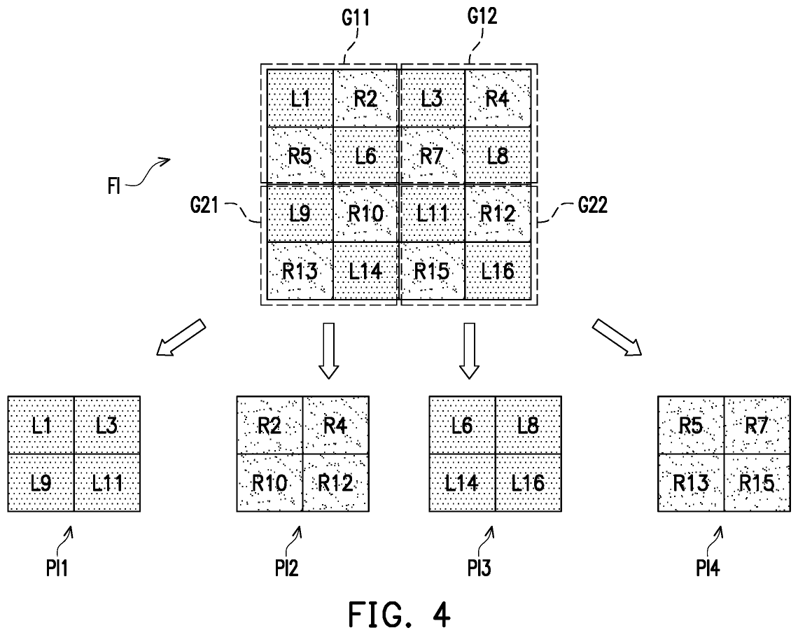

After obtaining the fusion image F1, the image processing device 103 may continue to execute steps S220 to S250 to generate the first projection image PI1, the second projection image PI2, the third projection image PI3, and the fourth projection image PI4 accordingly. For ease of understanding, a further description is provided below with reference to FIG. 4.

Referring to FIG. 4, FIG. 4 is a schematic diagram of generating a projected image based on the fusion image shown in FIG. 3. In this embodiment, after obtaining the fusion image F1 in FIG. 3, the image processing device 103 executes step S220 to generate a first projection image PI1 based on multiple first pixels of the multiple pixel groups G11, G12, G21, and G22.

For example, the image processing device 103 may extract the first pixels in each of the pixel groups G11, G12, G21, and G22 to form the first projection image PI1. In the scenario of FIG. 3 and FIG. 4, it is assumed that the first pixel of the pixel group G11 is the first eye pixel L1, the first pixel of the pixel group G12 is the first eye pixel L3, the first pixel of the pixel group G21 is the first eye pixel L9, and the first pixel of the pixel group G22 is the first eye pixel L11. In this case, the image processing device 103 may combine the first eye pixels L1, L3, L9, and L11 into a first projection image PI1.

From another point of view, the image processing device 103 may also be understood as extracting the upper left pixel of each of the pixel groups G11, G12, G21, and G22 to form the first projection image PI1 accordingly, but not limited thereto.

In step S230, the image processing device 103 generates a second projection image PI2 based on multiple second pixels of the pixel groups.

For example, the image processing device 103 may extract the second pixels in each of the pixel groups G11, G12, G21, and G22 to form the second projection image PI2. In the scenario of FIG. 3 and FIG. 4, it is assumed that the second pixel of the pixel group G11 is the second eye pixel R2, the second pixel of the pixel group G12 is the second eye pixel R4, the second pixel of the pixel group G21 is the second eye pixel R10, and the second pixel of the pixel group G22 is the second eye pixel R12. In this case, the image processing device 103 may combine the second eye pixels R2, R4, R10, and R12 into a second projection image PI2.

From another point of view, the image processing device 103 may also be understood as extracting the upper right pixel of each of the pixel groups G11, G12, G21, and G22 to form the second projection image PI2 accordingly, but not limited thereto.

In step S240, the image processing device 103 generates a third projection image PI3 based on multiple third pixels of the pixel groups.

For example, the image processing device 103 may extract the third pixels in each of the pixel groups G11, G12, G21, and G22 to form the third projection image PI3. In the scenario of FIG. 3 and FIG. 4, it is assumed that the third pixel of the pixel group G11 is the first eye pixel L6, the third pixel of the pixel group G12 is the first eye pixel L8, the third pixel of the pixel group G21 is the first eye pixel L14, and the third pixel of the pixel group G22 is the first eye pixel L16. In this case, the image processing device 103 may combine the first eye pixels L6, L8, L14, and L16 into a third projection image PI3.

From another point of view, the image processing device 103 may also be understood as extracting the lower right pixel of each of the pixel groups G11, G12, G21, and G22 to form the third projection image PI3 accordingly, but not limited thereto.

In step S250, the image processing device 103 generates a fourth projection image PI4 based on multiple fourth pixels of the pixel groups.

For example, the image processing device 103 may extract the fourth pixels in each of the pixel groups G11, G12, G21, and G22 to form the fourth projection image PI4. In the scenario of FIG. 3 and FIG. 4, it is assumed that the fourth pixel of the pixel group G11 is the second eye pixel R5, the fourth pixel of the pixel group G12 is the second eye pixel R7, the fourth pixel of the pixel group G21 is the second eye pixel R13, and the fourth pixel of the pixel group G22 is the second eye pixel R15. In this case, the image processing device 103 may combine the second eye pixels R5, R7, R13, and R15 into a fourth projection image PI4.

From another point of view, the image processing device 103 may also be understood as extracting the lower left pixel of each of the pixel groups G11, G12, G21, and G22 to form the fourth projection image PI4 accordingly, but not limited thereto.

It should be understood that although the steps S220 to S250 are shown as being executed sequentially in FIG. 2, in other embodiments, the execution order of the steps S220 to S250 may be adjusted according to the requirements of the designer. In an embodiment, the steps S220 to S250 may also be executed simultaneously, but not limited thereto.

After generating the first projection image PI1, the second projection image PI2, the third projection image PI3, and the fourth projection image PI4, in step S260, the image shifting device 104 sequentially projects the first projection image PI1, the second projection image PI2, the third projection image PI3, and the fourth projection image PI4. The first projection image PI1 and the third projection image PI3 correspond to the first eye image EI1, and the second projection image PI2 and fourth projection image PI4 correspond to the second eye image EI2.

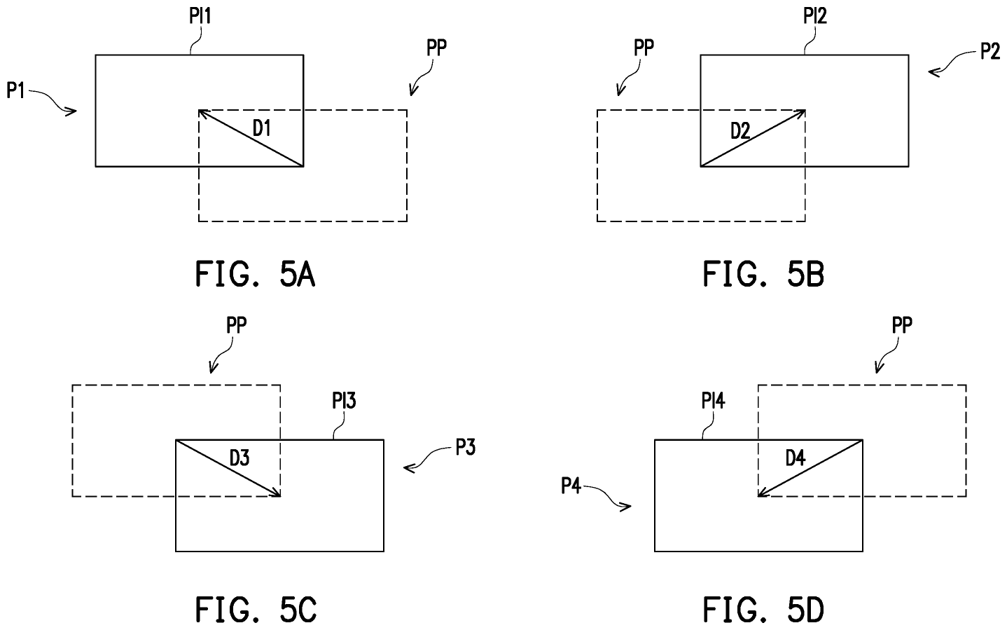

Referring to FIG. 5A to FIG. 5D, FIG. 5A to FIG. 5D are schematic diagrams of projecting multiple projection images according to FIG. 4.

In FIG. 5A, the image shifting device 104 shifts the first projection image PI1 to the first position P1 along the first direction D1. In one embodiment, the image shifting device 104 may shift the first projection image PI1 to the first position P1 by, for example, adjusting the configuration of the four-way actuator. In this embodiment, the image shifting device 104 may shift the first projection image PI1 from the preset position PP to the first position P1 along the first direction D1. In this case, the shifted first projection image PI1 may be further projected onto the corresponding projection surface through the projection lens 106.

In FIG. 5B, the image shifting device 104 shifts the second projection image PI2 to the second position P2 along the second direction D2. In one embodiment, the image shifting device 104 may shift the second projection image PI2 to the second position P2 by, for example, adjusting the configuration of the four-way actuator. In this embodiment, the image shifting device 104 may shift the second projection image PI2 from the preset position PP to the second position P2 along the second direction D2. In this case, the shifted second projection image PI2 may be further projected onto the corresponding projection surface through the projection lens 106.

In FIG. 5C, the image shifting device 104 shifts the third projection image PI3 to the third position P3 along the third direction D3. In one embodiment, the image shifting device 104 may shift the third projection image PI3 to the third position P3 by, for example, adjusting the configuration of the four-way actuator. In this embodiment, the image shifting device 104 may shift the third projection image PI3 from the preset position PP to the third position P3 along the third direction D3. In this case, the shifted third projection image PI3 may be further projected onto the corresponding projection surface through the projection lens 106.

In FIG. 5D, the image shifting device 104 shifts the fourth projection image PI4 to the fourth position P4 along the fourth direction D4. In one embodiment, the image shifting device 104 may shift the fourth projection image PI4 to the fourth position P4 by, for example, adjusting the configuration of the four-way actuator. In this embodiment, the image shifting device 104 may shift the fourth projection image PI4 from the preset position PP to the fourth position P4 along the fourth direction D4. In this case, the shifted fourth projection image PI4 may be further projected onto the corresponding projection surface through the projection lens 106.

In addition, in FIG. 5A to FIG. 5D, the second direction D2 is perpendicular to the first direction D1, the third direction D3 is opposite to the first direction D1, and the fourth direction D4 is opposite to the second direction D2.

In an embodiment, the first projection image PI1, the second projection image PI2, the third projection image PI3, and the fourth projection image PI4 may have the same shifted distance. That is, the distances between each of the first position P1, the second position P2, the third position P3 and the fourth position P4 and the preset position PP are all equal, but not limited thereto.

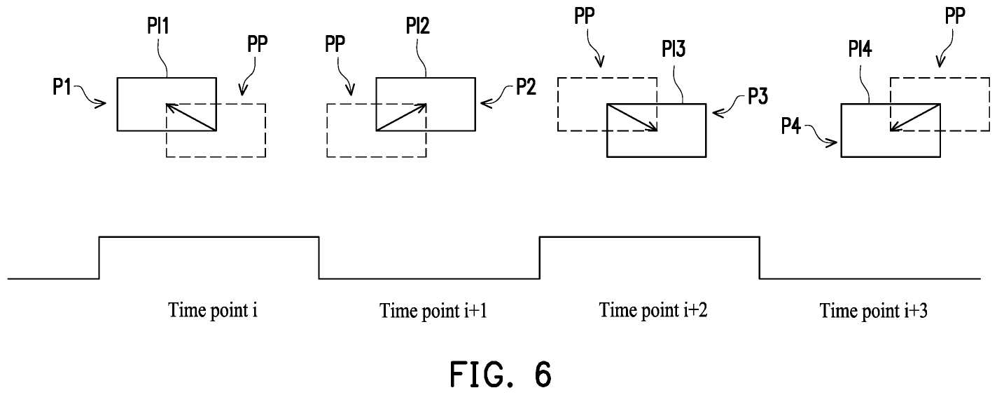

In one embodiment, the image shifting device 104 may perform the operations shown in FIG. 5A to FIG. 5D in sequence. Referring to FIG. 6, FIG. 6 is a schematic diagram of sequentially projecting multiple projection images according to FIG. 5A to FIG. 5D.

In FIG. 6, the image shifting device 104 performs the following operation. The first projection image PI1 is shifted to the first position P1 at a time point i (i is a time index value). The second projection image PI2 is shifted to the second position P2 at a time point i+1. The third projection image PI3 is shifted to the third position P3 at a time point i+2. The fourth projection image PI4 is shifted to the fourth position P4 at a time point i+3.

In one embodiment, in response to the first projection image PI1 being shifted to the first position P1, the image processing device 103 controls the 3D glasses to enable the first lens (e.g., the left eye lens) corresponding to the first eye (e.g., the left eye) of the user, and disable the second lens (e.g., the right eye lens) corresponding to the second eye (e.g., the right eye) of the user. In FIG. 6, the image processing device 103 may, for example, enable the first lens and disable the second lens at time point i. In this way, the user may only see the shifted first projection image PI1 through the first eye.

In one embodiment, in response to the second projection image PI2 being shifted to the second position P2, the image processing device 103 controls the 3D glasses to disable the first lens corresponding to the first eye and enable the second lens corresponding to the second eye. In FIG. 6, the image processing device 103 may, for example, enable the second lens and disable the first lens at time point i+1. In this way, the user may only see the shifted second projection image PI2 through the second eye.

In one embodiment, in response to the third projection image PI3 being shifted to the third position P3, the image processing device 103 controls the 3D glasses to enable the first lens corresponding to the first eye and disable the second lens corresponding to the second eye. In FIG. 6, the image processing device 103 may, for example, enable the first lens and disable the second lens at time point i+2. In this way, the user may only see the shifted third projection image PI3 through the first eye.

In one embodiment, in response to the fourth projection image PI4 being shifted to the fourth position P4, the image processing device 103 controls the 3D glasses to disable the first lens corresponding to the first eye and enable the second lens corresponding to the second eye.

In FIG. 6, the image processing device 103 may, for example, enable the second lens and disable the first lens at time point i+3. In this way, the user may only see the shifted fourth projection image PI4 through the second eye.

In an embodiment, the time difference between adjacent time points in FIG. 6 may be less than 1/120 second. That is, the 3D projection device 100 may project the shifted first projection image PI1, second projection image PI2, third projection image PI3, and fourth projection image PI4 at a frequency higher than 120 Hz. In this way, the persistence of vision phenomenon may appear in the eyes of the user wearing the 3D glasses, so that the user may view the 3D display content projected by the 3D projection device 100.

In addition, as shown in FIG. 4, the first pixel and the third pixel of each of the pixel groups G11, G12, G21, and G22 are arranged diagonally (e.g., the first eye pixels L1 and L6 in the pixel group G11), and the first pixel and the third pixel of the pixel groups G11, G12, G21, and G22 are respectively sampled to form the first projection image PI1 and the third projection image PI3. In this case, according to the Pythagorean theorem, the resolution jointly provided by the first projection image P1 and the third projection image PI3 is only decreased by √2 times compared with the first eye image EI1. For example, assuming that the resolution of the first eye image EI1 is 3840*2160, the resolution jointly provided by the first projection image PI1 and the third projection image PI3 is 2712*1528, among them, 2712 is 3840/√2, and 1528 is 2160/√2.

Similarly, the second pixel and the fourth pixel of each of the pixel groups G11, G12, G21, and G22 are arranged diagonally (e.g., the second eye pixels R2 and R5 in the pixel group G11), and the second pixel and the fourth pixel of the pixel groups G11, G12, G21, and G22 are respectively sampled to form the second projection image PI2 and the fourth projection image PI4. In this case, according to the Pythagorean theorem, the resolution jointly provided by the second projection image PI2 and the fourth projection image PI4 is only decreased by √2 times compared with the second eye image EI2. For example, assuming that the resolution of the second eye image EI2 is 3840*2160, the resolution jointly provided by the second projection image PI2 and the fourth projection image PI4 is 2712*1528, wherein 2712 is 3840/√2, and 1528 is 2160/√2.

It may be seen that, compared with the conventional method, the method proposed in the embodiment of the present invention may achieve better resolution without reducing the projection frequency.

To sum up, the method of the embodiment of the present invention may use the pixels in each of the pixel groups to form different projections after generating a fusion image including multiple pixel groups based on the first eye image and the second eye image in a specific manner, and the projection images corresponding to both eyes of the user are projected in turn. In this way, the effect of residual vision may be achieved in the eyes of the user, so that the user may enjoy the experience of viewing 3D projection content with good resolution.

However, the above are only preferred embodiments of the disclosure and are not intended to limit the scope of the disclosure; that is, all simple and equivalent changes and modifications made according to the claims and the contents of the disclosure are still within the scope of the disclosure. In addition, any of the embodiments or the claims of the disclosure are not required to achieve all of the objects or advantages or features disclosed herein. In addition, the abstract and title are provided to assist in the search of patent documents and are not intended to limit the scope of the disclosure. In addition, the terms “first,” “second” and the like mentioned in the specification or the claims are used only to name the elements or to distinguish different embodiments or scopes and are not intended to limit the upper or lower limit of the number of the elements.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A 3D projection method, adapted to a 3D projection device, comprising:
obtaining a first eye image and a second eye image, and forming a fusion image of the first eye image and the second eye image, wherein the fusion image comprises a plurality of pixel groups, and each of the plurality of pixel groups comprises a first pixel, a second pixel, a third pixel, and a fourth pixel;
generating a first projection image based on the first pixels of the plurality of pixel groups;
generating a second projection image based on the second pixels of the plurality of pixel groups;
generating a third projection image based on the third pixels of the plurality of pixel groups;
generating a fourth projection image based on the fourth pixels of the plurality of pixel groups; and
sequentially projecting the first projection image, the second projection image, the third projection image, and the fourth projection image, wherein the first projection image and the third projection image correspond to the first eye image, the second projection image and the fourth projection image correspond to the second eye image, the first eye image is one of a left eye image and a right eye image, and the second eye image is another one of the left eye image and the right eye image.

2. The 3D projection method according to claim 1, wherein the first pixel, the second pixel, the third pixel, and the fourth pixel in each of the plurality of pixel groups are arranged into a 2×2 pixel array, the first pixel and the third pixel in each of the plurality of pixel groups are arranged along a first diagonal direction, and the second pixel and the fourth pixel in each of the plurality of pixel group are arranged along a second diagonal direction perpendicular to the first diagonal direction.

3. The 3D projection method according to claim 2, wherein the first pixel and the third pixel in each of the plurality of pixel groups are from the first eye image, and the second pixel and the fourth pixel in each of the plurality of pixel groups are from the second eye image.

4. The 3D projection method according to claim 1, wherein the plurality of pixel groups comprise a first pixel group, the first pixel in the first pixel group has a first coordinate in the fusion image, the first eye image comprises a plurality of first eye pixels, and the method comprises:
finding a first reference eye pixel from the plurality of first eye pixels, wherein the first reference eye pixel corresponds to the first coordinate in the first eye image; and
setting the first pixel in the first pixel group to correspond to the first reference eye pixel.

5. The 3D projection method according to claim 4, wherein the second pixel in the first pixel group has a second coordinate in the fusion image, the second eye image comprises a plurality of second eye pixels, and the method comprises:
finding a second reference eye pixel from the plurality of second eye pixels, wherein the second reference eye pixel corresponds to the second coordinate in the second eye image; and
setting the second pixel in the first pixel group to correspond to the second reference eye pixel.

6. The 3D projection method according to claim 1, wherein the step of sequentially projecting the first projection image, the second projection image, the third projection image, and the fourth projection image comprises:
shifting the first projection image to a first position along a first direction by an image shifting device of the 3D projection device;
shifting the second projection image to a second position along a second direction by the image shifting device;
shifting the third projection image to a third position along a third direction by the image shifting device; and
shifting the fourth projection image to a fourth position along a fourth direction by the image shifting device.

7. The 3D projection method according to claim 6, wherein the first projection image, the second projection image, the third projection image, and the fourth projection image have a same shifted distance.

8. The 3D projection method according to claim 6, wherein the second direction is perpendicular to the first direction, the third direction is opposite to the first direction, and the fourth direction is opposite to the second direction.

9. The 3D projection method according to claim 6, comprising:
shifting the first projection image from a preset position to the first position along the first direction, shifting the second projection image from the preset position to the second position along the second direction, shifting the third projection image from the preset position to the third position along the third direction, and shifting the fourth projection image from the preset position to the fourth position along the fourth direction by the image shifting device.

10. The 3D projection method according to claim 6, comprising:
in response to the first projection image being shifted to the first position, controlling a 3D glasses to enable a first lens corresponding to the first eye and disable a second lens corresponding to the second eye;
in response to the second projection image being shifted to the second position, controlling the 3D glasses to disable the first lens corresponding to the first eye and enable the second lens corresponding to the second eye;
in response to the third projection image being shifted to the third position, controlling the 3D glasses to enable the first lens corresponding to the first eye and disable the second lens corresponding to the second eye; and
in response to the fourth projection image being shifted to the fourth position, controlling the 3D glasses to disable the first lens corresponding to the first eye and enable the second lens corresponding to the second eye.

11. A 3D projection device, comprising:
an image processing device, configured to perform:
obtaining a first eye image and a second eye image, and fusing the first eye image and the second eye image as a fusion image, wherein the fusion image comprises a plurality of pixel groups, and each of the plurality of pixel groups comprises a first pixel, a second pixel, a third pixel, and a fourth pixel;
generating a first projection image based on the first pixels of the plurality of pixel groups;
generating a second projection image based on the second pixels of the plurality of pixel groups;
generating a third projection image based on the third pixels of the plurality of pixel groups;
generating a fourth projection image based on the fourth pixels of the plurality of pixel groups; and
an image shifting device, coupled to the image processing device and configured to perform:
sequentially projecting the first projection image, the second projection image, the third projection image, and the fourth projection image, wherein the first projection image and the third projection image correspond to the first eye image, the second projection image and the fourth projection image correspond to the second eye image, the first eye image is one of a left eye image and a right eye image, and the second eye image is another one of the left eye image and the right eye image.

12. The 3D projection device according to claim 11, wherein the first pixel, the second pixel, the third pixel, and the fourth pixel in each of the plurality of pixel groups are arranged into a 2×2 pixel array, the first pixel and the third pixel in each of the plurality of pixel groups are arranged along a first diagonal direction, and the second pixel and the fourth pixel in each of the plurality of pixel group are arranged along a second diagonal direction perpendicular to the first diagonal direction.

13. The 3D projection device according to claim 12, wherein the first pixel and the third pixel in each of the plurality of pixel groups are from the first eye image, and the second pixel and the fourth pixel in each of the plurality of pixel groups are from the second eye image.

14. The 3D projection device according to claim 11, wherein the plurality of pixel groups comprise a first pixel group, the first pixel in the first pixel group has a first coordinate in the fusion image, the first eye image comprises a plurality of first eye pixels, and the image processing device is configured to perform:
finding a first reference eye pixel from the plurality of first eye pixels, wherein the first reference eye pixel corresponds to the first coordinate in the first eye image; and
setting the first pixel in the first pixel group to correspond to the first reference eye pixel.

15. The 3D projection device according to claim 14, wherein the second pixel in the first pixel group has a second coordinate in the fusion image, the second eye image comprises a plurality of second eye pixels, and the image processing device is configured to perform:
finding a second reference eye pixel from the plurality of second eye pixels, wherein the second reference eye pixel corresponds to the second coordinate in the second eye image; and
setting the second pixel in the first pixel group to correspond to the second reference eye pixel.

16. The 3D projection device according to claim 11, wherein the image shifting device is configured to perform:
shifting the first projection image to a first position along a first direction;
shifting the second projection image to a second position along a second direction;
shifting the third projection image to a third position along a third direction; and
shifting the fourth projection image to a fourth position along a fourth direction.

17. The 3D projection device according to claim 16, wherein the first projection image, the second projection image, the third projection image, and the fourth projection image have a same shifted distance.

18. The 3D projection device according to claim 16, wherein the second direction is perpendicular to the first direction, the third direction is opposite to the first direction, and the fourth direction is opposite to the second direction.

19. The 3D projection device according to claim 16, wherein the image shifting device is configured to perform:
shifting the first projection image from a preset position to the first position along the first direction, shifting the second projection image from the preset position to the second position along the second direction, shifting the third projection image from the preset position to the third position along the third direction, and shifting the fourth projection image from the preset position to the fourth position along the fourth direction.

20. The 3D projection device according to claim 16, wherein the image processing device is configured to perform:
in response to the first projection image being shifted to the first position, controlling a 3D glasses to enable a first lens corresponding to the first eye and disable a second lens corresponding to the second eye;
in response to the second projection image being shifted to the second position, controlling the 3D glasses to disable the first lens corresponding to the first eye and enable the second lens corresponding to the second eye;
in response to the third projection image being shifted to the third position, controlling the 3D glasses to enable the first lens corresponding to the first eye and disable the second lens corresponding to the second eye; and
in response to the fourth projection image being shifted to the fourth position, controlling the 3D glasses to disable the first lens corresponding to the first eye and enable the second lens corresponding to the second eye.
